(19) United States
(12) Patent Application Publication
(10) Pub. No.: US 2017/0080526 A1
(43) Pub. Date: Mar. 23, 2017

(54) ADDITIVE MANUFACTURING USING CAST STRIP SUPERALLOY MATERIAL

(71) Applicant: Siemens Energy, Inc., Orlando, FL (US)

(72) Inventor: Gerald J. Bruck, Titusville, FL (US)

(21) Appl. No.: 14/860,002

(22) Filed: Sep. 21, 2015

(51) Int. Cl. B23K 26/342; B23K 11/16; B23K 11/02

(52) U.S. Cl. CPC B23K 26/342; B23K 11/02; B23K 11/16; B33Y 10/00

(57) ABSTRACT

A method of additive manufacturing, including: placing a layer (10) of strip-cast superalloy sheet material over a subcomponent (12) leaving a gap (20) between the layer and the subcomponent; and creating a weldment (14) to the layer. Shrinkage in the layer caused by the weldment is accommodated by a decrease in the gap with reduced shrinkage stress in the weldment. The layer may be formed of more than one piece (16), and the weldment may join the pieces together with or without joining the layer to the subcomponent. The gap may again grow due to differential thermal expansion when the resulting component is placed into service, thereby functioning as a passively regulated cooling channel.

### FIELD OF THE INVENTION

The invention relates generally to the field of additive manufacturing, and more particularly to building-up a component with cast superalloy material by welding layers of strip-cast superalloy material with an allowance in the build to allow weld related shrinkage to occur without restraint.

### BACKGROUND OF THE INVENTION

Gas turbine engine components operate in extremely harsh environments and this often necessitates that they be made using superalloy materials. Superalloys are difficult to cast in a manner that achieves uniform properties throughout the component. This is largely related to the challenge of removing enough heat from the melt at a consistent rate throughout the part's cross section during the casting operation. Typically, the center of the part is last to solidify because heat is extracted from the periphery of the melt. A similar issue happens in welding superalloys where the weld centerline is last to solidify and where centerline segregations and shrinkage issues can lead to solidification cracking.

Part specific casting is also labor-intensive, time consuming, and costly. Typical steps to generate a specific cast geometry include die fabrication, wax injection, assembly on a sprue, shell building (coating with ceramic slurry and sand stucco), drying, wax removal in an autoclave, furnace burnout, mold filling with metal, shell removal, gate removal, and final sandblasting and machining.

Some recent interest has been devoted to selective laser melting (SLM) to build parts by additive manufacturing. The SLM process is, however, relatively slow, limited to buildups in a horizontal plane (e.g. no part extending above the plane), and limited to fine grain structure. SLM also results in properties that are different in the direction of building than in other directions.

Consequently, there remains room in the art for uniform, predictable, and even customizable properties throughout a superalloy component, as well as a need for faster part production.

### BRIEF DESCRIPTION OF THE DRAWINGS

The invention is explained in the following description in view of the drawings that show:

FIG. 1 is a top view depicting the addition of a layer in an additive manufacturing process.

FIG. 2 is a top view depicting the addition of a layer in an alternate exemplary embodiment of the additive manufacturing process of FIG. 1.

FIG. 3 is a side view depicting the addition of a layer in an alternate exemplary embodiment of the additive manufacturing process.

FIG. 4 is a top view depicting the addition of the layer of FIG. 3.

FIG. 5 is a side view depicting the addition of another layer of the alternate exemplary embodiment of FIG. 3.

FIGS. 6-8 depict an alternate exemplary embodiment of the process of forming the other layer of FIG. 5.

### DETAILED DESCRIPTION OF THE INVENTION

The present inventor has developed a unique and innovative approach to additive manufacturing of a component using cast superalloy material that overcomes drawbacks associated with existing techniques. The inventor has recognized that thinner sections of superalloy are less prone to centerline casting issues because they solidify more consistently across their narrow section. Consequently, a process known as strip casting provides faster and more uniform cooling, refinement of microstructure, and improved uniformity of composition. The method disclosed herein takes advantage of these properties and also overcomes weld cracking associated with superalloys. The result is an additive manufacturing process that produces a superalloy component having cast alloy grain structure while avoiding problems normally associated with casting. The process utilizes relatively inexpensive, bulk strip cast superalloy substrate material.

The method disclosed herein proposes to manufacture fully cast parts in an additive fashion. The method includes layering cast superalloy strip material to build up the parts in an additive process. The cast material has superior properties than wrought material. Moreover, the present invention utilizes defined gaps around the strips to accommodate subsequent weld shrinkage (e.g. mitigating restraint) when welding each strip to itself and/or to an underlying subcomponent (that may include other layers of strip cast superalloy material). The welded component is then available for final machining and heat treatment. Structural details in any given strip layer or between given strip layers can be achieved by pre-forming the strip or by an intermediate machining step. Such details include, for example, pockets, holes, channels/passageways etc. Certain such details may be so fine, intricate and complex that they could not be achieved by conventional casting practices. Incremental, additive layered construction as described herein provides a unique opportunity to introduce internal manufacturing details never before possible in cast components. Such passageways could be continuous or could be dead-ended and could serve any number of functions including cooling, temperature instrumentation, stress instrumentation, inspection, etc.

Mitigating shrinkage stress (eliminating or reducing the stress compared to fully restrained welding) associated with welding the superalloy layers facilitates the avoidance of weld solidification cracking and weld reheat cracking. This may be accomplished in a variety of ways, depending on the geometry of the layer and its position in the component being formed.

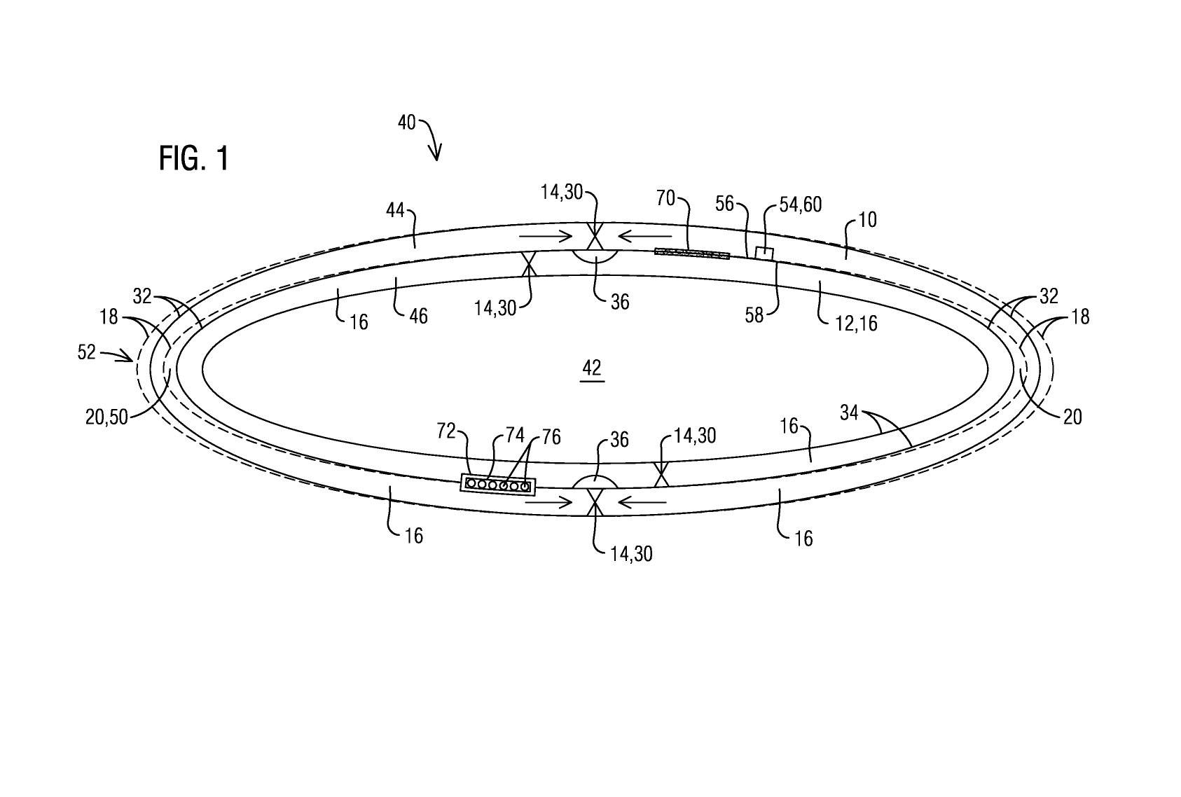

FIG. 1 is a cross sectional view depicting the addition of a layer 10 to a subcomponent 12 in an additive manufacturing process. As used herein, the subcomponent 12 is any unfinished part of a component to which the layer 10 is being added. The subcomponent 12 may be composed fully of other layers of strip cast superalloy material. Alternately, the subcomponent 12 may include non superalloy material, or a mix of other strip cast superalloy layers and non superalloy material. In this exemplary embodiment the subcomponent 12 is another layer of strip cast superalloy material including a weld 14.

The layer 10 being added includes two pieces 16 having an oversized pre-weld profile 18 as indicated by dashed lines. The pre-weld profile 18 forms a gap 20 between the subcomponent 12 and the layer 10. Upon butt-welding the two pieces 16 together, weld shrinkage transverse to the joints 30 (as shown by the arrows) causes the layer 10 to become smaller, thereby reducing or eliminating the gap 20, as shown by the solid line indicating a post-weld profile 32. The gap 20 therefore accommodates the shrinkage because it permits the weld 14 in layer 10 to shrink without being restrained by the subcomponent 12. Without the gap 20, the layer 10 would begin to shrink, but would be restrained from doing so by the subcomponent 12, which may already be in a final form. When restrained by the subcomponent 12 the weld 14 would experience additional stress which could cause weld solidification cracking and weld reheat cracking. The process may be repeated to add additional layers.

While shown as a concentric wrap having two pieces butt welded together, other types of layer configurations may be used, including spiral wraps that are fillet welded, and coil winding etc. Varying the thicknesses of overlapping layers is also possible. Further, varying a thickness of the component locally by varying the size and shape of the layer is also possible. Still further, varying the material type of a layer or portion of a layer is possible to impart desired changes in properties.

In an alternate exemplary embodiment, the gap 20 may accommodate enough shrinkage to prevent the weld solidification cracking and weld reheat cracking, but may permit some restraint of the shrinkage. This may be advantageous when pre-stressing is desirable. In such an exemplary embodiment, the layer 10 may experience some pre-tension, while the subcomponent 12 may experience some pre-compression. In such an exemplary embodiment, weld shrinkage may initially be unrestrained by the subcomponent 12, after which the subcomponent 12 will restrain any remaining shrinkage. Stress in the weldment will be lower than in a weldment that is fully restrained. By way of example, pre-stressing of the innermost layer and introduction of compressive stresses could be of advantage if the interior represented a conduit for fluid that would otherwise cause stress corrosion cracking (tensile stress induced).

In an exemplary embodiment where the subcomponent 12 is likewise formed by butt welding strip cast superalloy material, the pieces 16 of the subcomponent 12 may similarly be oversized pre-weld to produce a desired post-weld profile 34. Alternately, the subcomponent 12 may be machined, cast using other casting techniques (e.g. lost wax), or forged, extruded, etc. Once the layer 10 is added to the subcomponent 12, the layer 10 is considered part of the subcomponent to which a next layer is added. The process of adding layers repeats until the component is completed.

The layer 10 may be welded to the subcomponent 12. For example, the weld 14 may join the pieces 16 to each other and may join layer 10 to the subcomponent 12. Alternately, the layer 10 may remain not bonded to the subcomponent 12. This may be accomplished in any number of ways. For example, the subcomponent 12 may include a recess 36 adjacent the weld 14 in the layer 10. In such an exemplary embodiment the weld 14 would join the pieces 16 of the layer 10, but would not join the layer 10 to the subcomponent. In this exemplary embodiment the welds 14 in the subcomponent were staggered from the welds 14 in the layer 10, i.e. not adjacent to each other in a through-thickness direction. The recess 36 may be formed, for example, by machining.

Joining the layer 10 to the subcomponent 12 may readily be accomplished simply by foregoing the recess 36, causing the weldment to incorporate material from the layer 10 and the subcomponent 12 and, if required, additional filler metal and metallurgically joining them together. In various embodiments the welds 14 may or may not align from one layer to the next.

The layer 10 and the subcomponent 12 in FIG. 1 may form a component wall 40 that encloses a hollow space 42. Accordingly, the additive manufacturing method disclosed herein may be used to form a pressure vessel such as for a boiler. Similarly, the process can be used to form an airfoil of a blade or a vane of a gas turbine engine, or a hot gas path duct such as a transition duct. In a component where an outer wall 44 is exposed to hot gases, such as when the component wall 40 forms an airfoil of a blade or vane, the arrangement may be particularly beneficial. When the outer wall 44 is exposed to the hot gases it may thermally grow relative to an inner wall 46. This relative thermal growth may form a cooling passage 50 that can carry cooling fluids. In the exemplary embodiment of FIG. 1, the cooling passage 50 may be naturally disposed at a leading edge 52 of the airfoil, advantageously exactly where a high need for cooling exists. Further, a size of the cooling passage 50 would vary depending on a temperature difference between the outer wall 44 and the inner wall 46. This characteristic may be relied upon to throttle the amount of cooling fluid used, providing for a self-regulating cooling passage.

A minimum amount of cooling may be provided by creating other cooling passages. A groove 54 may be machined into a surface 56 of the layer 10, a surface 58 the subcomponent 12, or both. When assembled together, the layer 10, the subcomponent, 12, and the groove 54 define a cooling passage 60. The recess 36 may also be used for cooling. The surface 56 of the layer, the surface 58 of the subcomponent 12, or both may be roughened to form a cooling passage 70. An insert recess 72 may be formed between the layer 10 and the subcomponent 12 and an insert 74 placed therein. The insert 74 may include cooling passages 76 or other cooling features, such as trip strips, turbulators etc. that guide/influence cooling flow in the cooling passages 76.

When not welded to the subcomponent 12, the layer 10 may be held in place through a mechanical interlock. For example, the outer layer 44 of an airfoil may remain free to float relative to the inner layer 46, but the movement may be limited by a blade platform or vane shroud.

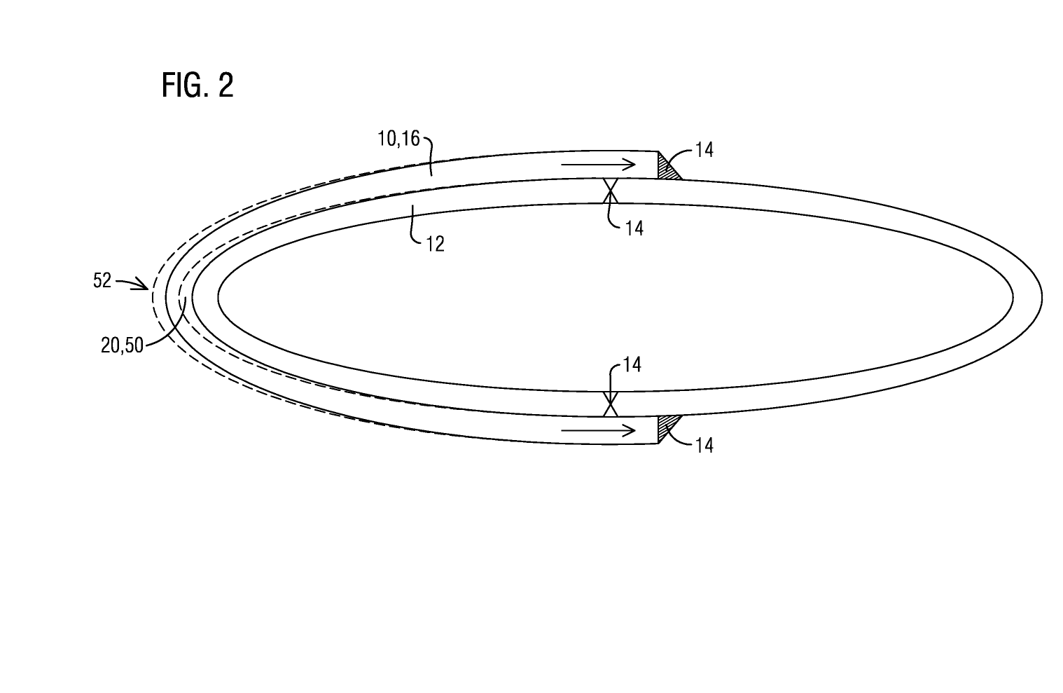

The layers 10 may be selectively applied as needed. This can be seen in FIG. 2, where the layer 10 is applied to a portion of the subcomponent 12. Here the layer 10 is metallurgically bonded (e.g. fillet welded) to the subcomponent 12. Similar to that process of FIG. 1, the layer 10 is oversized and creates the gap 20 to accommodate the shrinkage. Selective application of layers 10 allows for more structure where needed without having unnecessary structure where it is not needed, which may save weight and cost and may facilitate balancing a component. Where the weld 14 bonds the layer 10 to the subcomponent 12 as shown in FIG. 2, the layer 10 is pinned at the weld 14 and will naturally expand to form the cooling passage 50 in a desired location, such as a leading edge 52 of an airfoil.

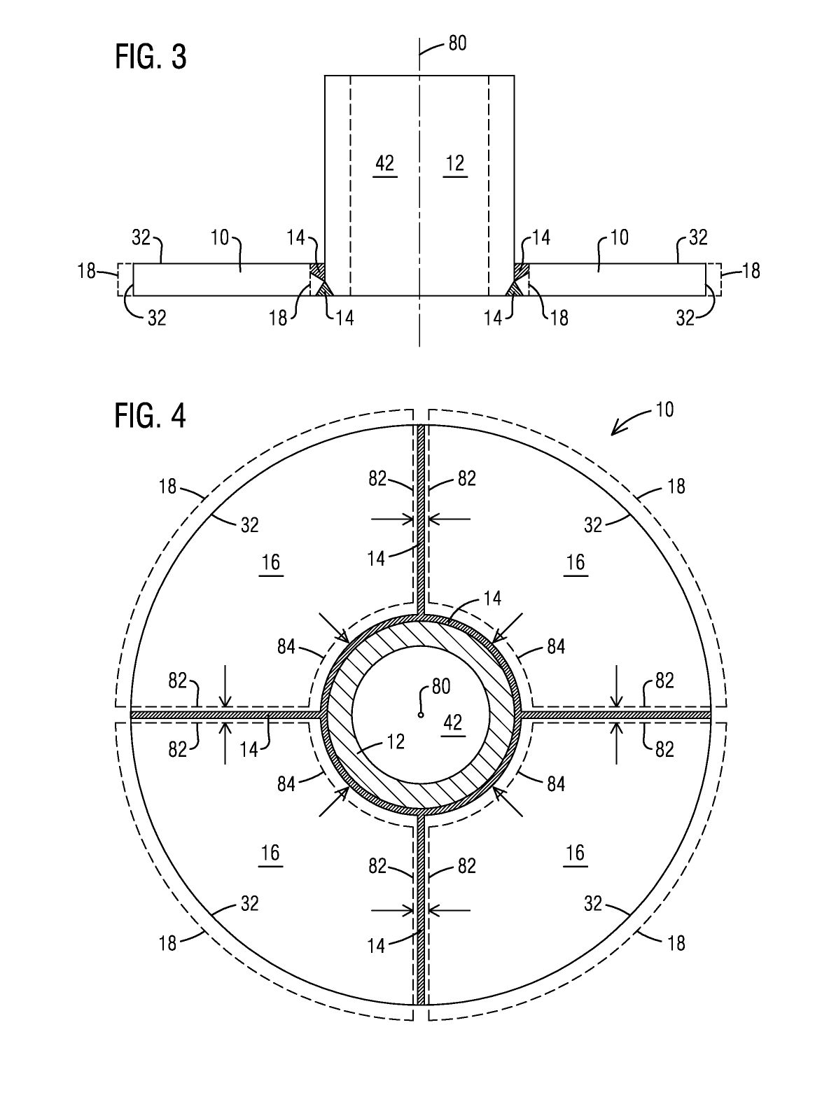

FIG. 3 shows a side view of a component such as a flange for a pressure vessel, a platform for a blade, or a shroud for a vane etc. The subcomponent 12 (e.g. a pipe or airfoil) again defines a hollow space 42, but the layer 10 is oriented transverse to the hollow space 42 and a long axis 80 of the subcomponent 12. The layer 10 includes an oversized pre-weld profile 18 that shrinks to form the post-weld profile 32. FIG. 4 shows the layer 10 and subcomponent 12 of FIG. 3 from a top view. The layer 10 includes plural pieces joined together via butt welds at edges 82 and joined via corner/t-joint welds to the subcomponent 12 at an inner periphery 84. Upon welding, the shrinkage transverse to the joints (as shown by the arrows) causes the layer 10 to shrink from the pre-weld profile 18 to the post-weld profile 32. In an alternate exemplary embodiment, the subcomponent 12 may include a groove (not shown) into which the inner periphery 84 may shrink, thereby creating a mechanical interference that could hold the layer 10 in place before welding. In this case the weld 14 at the inner periphery 84 may be optional.

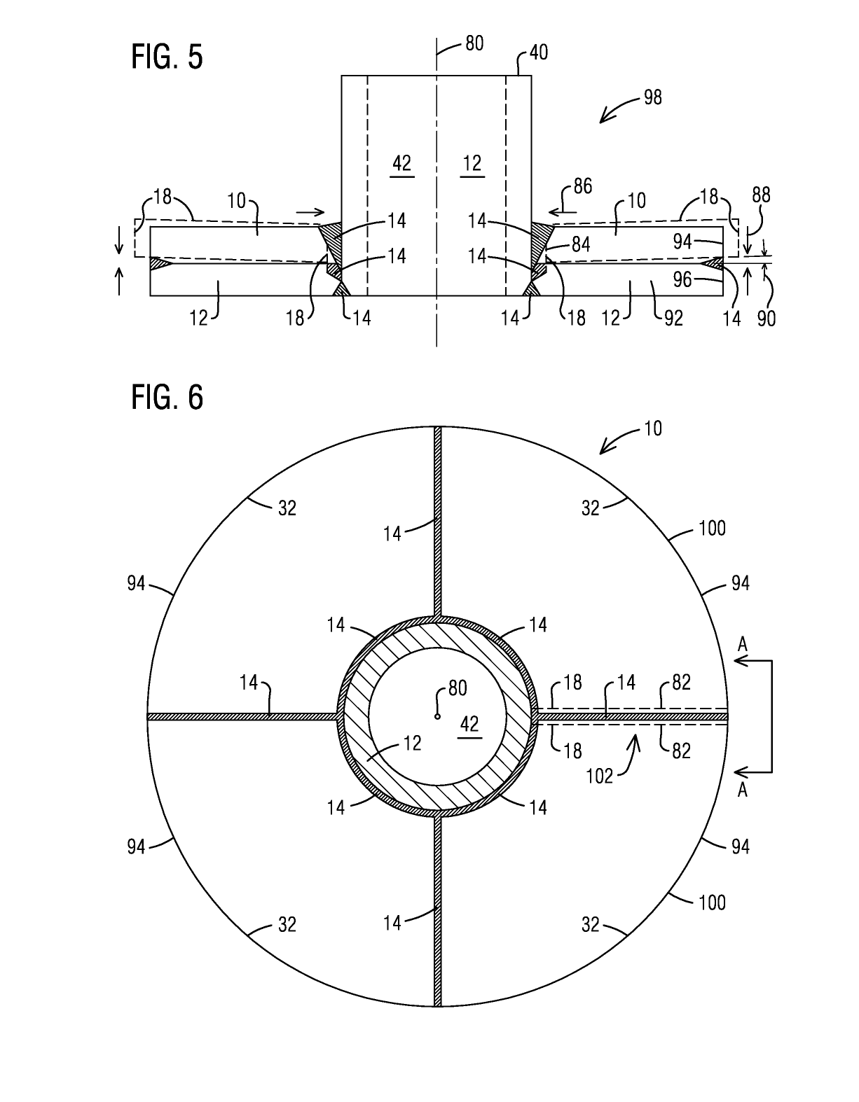

In FIG. 5 the layer 10 and the subcomponent 12 of FIGS. 3-4 become the subcomponent to which a new layer 10 is added. In the case of a flange for a pressure vessel, adding the layer 10 may build up the flange. In the case of a blade, adding the layer 10 may build up the platform. In the case of a vane, adding the layer 10 may build up the shroud.

When adding a layer 10 to a subcomponent 12 such that the layer 10 may shrink in two different directions, e.g. a radially inward direction 86 and a transverse direction 88, additional allowance may be necessary to accommodate the differing shrinkages. Similar to FIG. 4, in FIG. 5 the layer 10 may include plural pieces 16 that are oversized. In addition, they are canted at a slight angle 90 to a transverse portion 92 of the subcomponent 12 as shown by the pre-weld profile 18. Upon butt welding the edges 82 to each other, corner/t-joint welding the inner periphery 84 to the component wall 40, and edge welding an outer periphery 94 of the layer 10 to an outer periphery 96 of the transverse portion 92 of the subcomponent 12, the combined shrinkage causes the layer 10 to shrink from the pre-weld profile 18 to the post-weld profile 32.

It should be noted that although assembly gaps in the layer 10 help to avoid shrinkage restraint, there may be increasing restraint as more and more welds are performed. For example, the first weld may be completely free to shrink and freely draw the pieces 16 together. The last weld, however, may be somewhat restrained by the subcomponent 12. In principle, this can be avoided or mitigated by using multiple energy sources to perform the welding such that all welds and all shrinkage occur at the same time. Multiple arc weld torches, multiple laser beams, time shared laser beams, multiple resistance welds, etc. could be applied to accomplish this.

In more common practice where welds are performed one at a time, sequencing of the welds will be helpful in minimizing the restraint during manufacture. For example, before completely welding a given joint, other joints could be partially started as well. As the joints continue to be performed some plastic yielding of partially deposited metal is possible to reduce restraint in the last welds to be completed.

The layer 10 and the subcomponent 12 of FIG. 5 could be considered the component 98 when at least one of the component wall 40 and the transverse portion 92 include at least one layer of strip cast superalloy material. For example, if the component wall 40 were fabricated with plural layers of strip cast superalloy material using the process shown in FIGS. 1 and/or 2, and the layer 10 is a strip cast superalloy, a component 98 may be considered formed. It is envisioned that the final component may include plural layers of strip cast superalloy material, and may be composed entirely of layers of strip cast superalloy material.

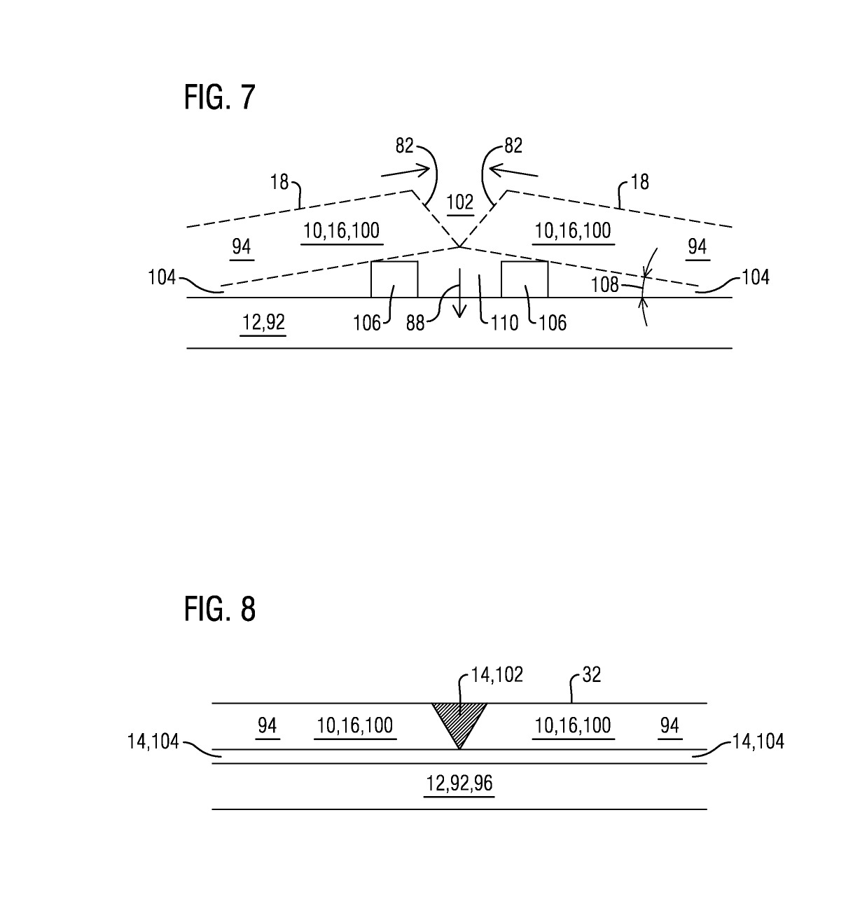

FIGS. 6-8 disclose another method for creating an allowance to accommodate shrinkage. FIG. 6 shows the layer 10 of FIG. 5 having all welds 14 completed except for the edges 82 of the last two pieces 100 to be joined at joint 102 and the outer periphery 94 of the layer 10 to be joined to the outer periphery 96 of the transverse portion 92 of the subcomponent 12 at joint 104. FIGS. 7-8 are taken along line A-A of FIG. 6. FIG. 7 shows the pre-weld profile 18, where wedges 106 angle the pieces 16 away from the transverse portion 92 of the subcomponent 12 and form an angle 108 and a gap 110 there between. As welding is performed the wedges 106 are slid out. Weld shrinkage causes the pieces 18 to rotate toward the transverse portion 92 in the transverse direction 88, decreasing the gap 110. Alternately, instead of gradual removal of the wedges 106, the gap 104 may be created by springs or, for example, a substance which sublimates upon heating such as dry ice, etc. Any mechanism is permissible to create gap 110 initially but to then permit restraint free shrinkage during the weld.

Various welding processes could be used to create the welds 14 used to accomplish additive manufacturing of cast components using layers of strip cast construction. Examples include arc welding, beam welding, resistance welding, and solid state welding. Brazing may be used for at least some areas to reduce shrinkage and to provide some structural joining, however, except for diffusion brazing or transient liquid phase bonding, brazing would normally result in lower structural strength of the final product than welding.

In addition, various material properties are possible with layered construction. For example, subsequent layers of different cast materials could be applied to create a part of varied properties throughout, such as improved oxidation resistance for the outermost layer.

Further, various cast microstructures are possible with layered construction. For example, one layer could be conventionally cast (polycrystalline), and a subsequent layer could be directionally solidified (DS). Cast and wrought materials could be layered together. One layer could be DS and the next layer could also be DS, but could be oriented at a different DS direction of the underlying layer. Limited control of the grain structure created during conventional strip casting of superalloys has been achieved. By example, Inconel® 606 has been strip cast producing fine columnar grains at the surface and equiaxed grains at the centerline. Also, alloy Ni₅₀Ti₅₀ has been strip cast with columnar grains extending from the surfaces of the strip to the centerline. Further development of the process will likely lead to more and better controlled advanced microstructures which can be used in the process disclosed herein.

From the foregoing it can be seen that the Inventor has devised an improved additive manufacturing process that uses strip cast superalloy material to create components. The strip cast superalloy material is readily available and can be cut to form any shape necessary for a layer. Therefore, it is no longer necessary to create molds etc. to form a part. All that is required is a computer model and a generic sheet of strip cast superalloy material that can be cut as necessary. Further, the assembly process is much quicker than conventional additive manufacturing processes such as SLM and utilizes welding techniques known to those in the art.

The strip cast superalloy material has a more uniform grain structure than conventionally cast superalloy components where, because of practical limitations of heat extraction, the last to solidify material is of large grain size and typically occurs toward the center of large parts. Alternately, consistency associated with strip casting improves component performance. The layers can be locally tailored and/or varied layer to layer in order to meet local component requirements, such as varying the material grain size, structure and/or orientation, varying the superalloy material composition, and/or varying the layer dimensions etc. The component can include strip cast superalloy layers and layers of other materials as well. All of this leads to an improved ability to locally tailor the component to meet local component requirements. This, in turn, enables cost savings because the entire component need not be manufactured with expensive materials necessary to withstand the harshest local requirement, as it must in a conventional casting process. As such, the process saves in capital costs, saves in manufacturing time and costs, produces a superior component, and does so more quickly than conventional processing. Therefore, it represents an improvement in the art.

The term “superalloy” is used herein as is understood in the art to describe a highly corrosion and oxidation resistant alloy that exhibits excellent mechanical strength and resistance to creep at high temperatures, as well as good surface stability. Superalloys are often used to form gas turbine engine hot gas path components. Superalloys typically include a base alloying element of nickel, cobalt or nickel-iron. Examples of superalloys include alloys sold under the trademarks and brand names Hastelloy, Inconel alloys (e.g., IN 700, IN 738, IN 792, IN 939), Rene alloys (e.g., Rene N5, Rene 80, Rene 142), Haynes alloys, Mar M, CM 247, CM 247 LC, C 263, 718, X-750, ECY 768, 282, X45, PWA 1483 and CMSX (e.g., CMSX-4, CMSX-8, CMSX-10) single crystal alloys.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of manufacturing a superalloy component, the method comprising:
placing a layer comprising strip-cast superalloy sheet material on a subcomponent,
leaving a gap between at least a portion of the layer and the subcomponent; and
forming a weld in the layer to form the superalloy component, wherein shrinkage in the layer caused by forming the weld decreases the gap, thereby mitigating weld shrinkage stress in the weld.

2. The method of claim 1, wherein the layer comprises plural pieces, the method further comprising welding the pieces together, wherein shrinkage in the layer caused by welding the pieces together decreases the gap.

3. The method of claim 2, further comprising butt welding respective edges of the plural pieces together, and presetting the plural pieces at an angle with respect to each other prior to the butt welding to establish the gap to accommodate shrinkage caused by the butt weld.

4. The method of claim 1, further comprising welding the layer to the subcomponent during the step of forming the weld.

5. The method of claim 1, further comprising forming the weld proximate a recess in the subcomponent such that a resulting weldment does not join the layer to the subcomponent.

6. The method of claim 1, wherein at least a portion of the gap remains following the step of forming the weld such that the remaining portion of the gap defines a cooling passage in the component.

7. The method of claim 1, further comprising forming a groove in at least one of the subcomponent or the layer prior to the step of placing the layer on the subcomponent in order to define a passageway in the component.

8. The method of claim 1, further comprising roughening a surface of at least one of the subcomponent or the layer prior to the step of placing the layer on the subcomponent in order to define a passageway in the component.

9. The method of claim 1, wherein the welded subcomponent and layer define a new subcomponent, and further comprising:
repeating the placing, leaving and forming steps to add subsequent new layers to respectively formed new subcomponents until a desired shape of the superalloy component is formed.

10. The method of claim 9, wherein a composition of strip-cast superalloy sheet material used for one of the layers is different than a composition of strip-cast superalloy sheet material used for another of the layers.

11. The method of claim 9, wherein grain orientation of strip-cast superalloy sheet material used for one of the layers is different than grain orientation of strip-cast superalloy sheet material used for another of the layers.

12. The method of claim 9, wherein weldments formed in the layers are not adjacent to each other in a through-thickness direction.

13. A superalloy component comprising a subcomponent and a layer of strip-cast superalloy sheet material joined by the method of claim 1.

14. A superalloy component comprising a plurality of layers of strip-cast superalloy sheet material joined by the method of claim 9.

15. The superalloy component of claim 14, wherein at least some of the layers are welded together.

16. The superalloy component of claim 14, further comprising a cooling passage formed between at least two of the layers.

17. The superalloy component of claim 16, wherein an outermost layer is free to grow away from an underlying layer due to thermal expansion during operation of the superalloy component in a hot environment, thereby causing a size of the cooling passage to change responsive to the hot environment.

18. A gas turbine engine comprising the component of claim 13.

19. A gas turbine engine comprising the component of claim 14.
